(19) United States
(12) Patent Application Publication
(10) Pub. No.: US 2017/0111961 A1
(43) Pub. Date: Apr. 20, 2017

(54) SYSTEM FOR WARMING UP AND/OR COOKING FOOD WITH MICROWAVE DETECTION

(71) Applicant: Indesit Company S.p.A., Fabriano (IT)

(72) Inventors: Carlo Filippo RATTI, Torino (IT); Marco Maria PEDRAZZO, Cueno (IT)

(21) Appl. No.: 15/301,632

(22) PCT Filed: Apr. 1, 2015
(86) PCT No.: PCT/IB2015/052402

§ 371 Date: Oct. 3, 2016

(30) Foreign Application Priority Data
Apr. 7, 2014 (IT) TO2014A000289

(51) Int. Cl. H05B 6/64

(52) U.S. Cl. CPC H05B 6/6435; H05B 6/6455

(57) ABSTRACT

A system for warming up and/or cooking food is provided herein and includes: a frame; operating means for heating an active zone defined within the volume delimited by said frame; an emitter device for irradiating said active zone with incident microwaves; a detector device for detecting corresponding radiations coming from said active zone; a first transmission unit associated with at least said detector device and configured for sending first data, representative of said corresponding radiations, to a processing unit.

### FIELD OF THE INVENTION

The present invention relates to a system for warming up and/or cooking food with microwave detection.

### PRIOR ART

As is known, preparing food by means of an oven poses a number of problems: since food is cooked in a closed environment, it is always difficult to tell when cooking is complete. In fact, although ovens are usually provided with a door that is at least partially transparent, and with lighting means mounted inside the oven itself, evaluating the actual degree of cooking is still a complex operation.

Moreover, when the user tries to overcome this problem by opening the door to directly observe the food, he/she will risk to interrupt the cooking cycle in an uncontrolled manner, thus making the continuation of the same more difficult and less deterministic, while also risking burns and scalds caused by the high temperature that can be reached inside the oven in operation.

### SUMMARY OF THE INVENTION

The present invention aims at providing a system which can solve the above-mentioned problems.

In particular, it is one object of the invention to provide a system which allows a more reliable evaluation of the degree of cooking of food being prepared, without requiring that the oven door be opened.

This and other objects are substantially achieved by a system in accordance with the appended claims.

A basic idea of the present invention is to envisage that the characteristics of the food being cooked in the oven can be detected through a microwave system and made available to the user.

The user can then verify the food cooking conditions, and possibly intervene in order to modify/stop the operation.

The user can also obtain some additional information, e.g., concerning food quality and composition, etc.

The invention therefore relates to a system for warming up and/or cooking food, comprising:

a frame; operating means for heating an active zone defined within the volume delimited by said frame;

an emitter device for irradiating said active zone with incident microwaves; a detector device for detecting corresponding radiations coming from said active zone; and

a first transmission unit associated with at least said detector device and configured for sending first data, representative of said corresponding radiations, to a processing unit.

Preferably, said corresponding radiations are generated by the interaction between said incident microwaves and food present in said active zone.

Preferably, said processing unit is configured for generating, based on said first data, one or more images representative of food present in said active zone.

Preferably, said processing unit is configured for determining, based on said first data, one or more of the following characteristic parameters:

a. a first parameter representative of the quality of the food present in the active zone;

b. a second parameter representative of a freshness of the food present in the active zone;

c. a third parameter representative of the volume occupied by the food present in the active zone;

d. a fourth parameter representative of the cooking level of the food present in the active zone; and

e. a set of parameters representative of a composition of the food present in said active zone, preferably comprising values concerning the relative quantity of skin and/or the relative quantity of meat and/or the relative quantity of water and/or the relative quantity of stuffing.

Preferably, said system further comprises a second transmission unit for sending second data to a display device.

Preferably, said second data comprise said one or more images.

Preferably, said second data comprise one or more of said characteristic parameters.

Preferably, said frame, said operating means, said emitter device, said detector device and said first transmission unit are parts of an oven.

Preferably, said oven is of the combined type.

Preferably, said emitter device is configured for being brought into an alternative operating condition in which it is adapted to warm up the food present in said active zone.

Preferably, said processing unit and said second transmission unit are integrated into said oven.

Preferably, said display device is integrated into a portable auxiliary device separate from said oven.

Preferably, said processing unit and said second transmission unit are integrated into a portable auxiliary device separate from said oven.

Preferably, said display device is integrated into said auxiliary device.

Further features and advantages will become more apparent from the following detailed description of a preferred but non-limiting embodiment of the invention.

### BRIEF DESCRIPTION OF THE DRAWINGS

Said description will refer to the annexed drawings, also provided merely as explanatory and non-limiting examples, wherein:

FIG. 1 is a block diagram representative of a first embodiment of a system according to the invention;

FIG. 2 is a block diagram representative of a second embodiment of a system according to the invention;

FIG. 2 is a block diagram representative of a second embodiment of a system according to the invention; and

FIGS. 3-5 schematically show operating conditions of the system of FIGS. 1-2.

The drawings show different aspects and embodiments of the present invention and, where appropriate, similar structures, components, materials and/or elements are designated in the various drawings by the same reference numerals.

### DETAILED DESCRIPTION OF THE PREFERRED EMBODIMENTS

With reference to the annexed drawings, reference numeral 1 designates as a whole a system for warming up and/or cooking food in accordance with the present invention.

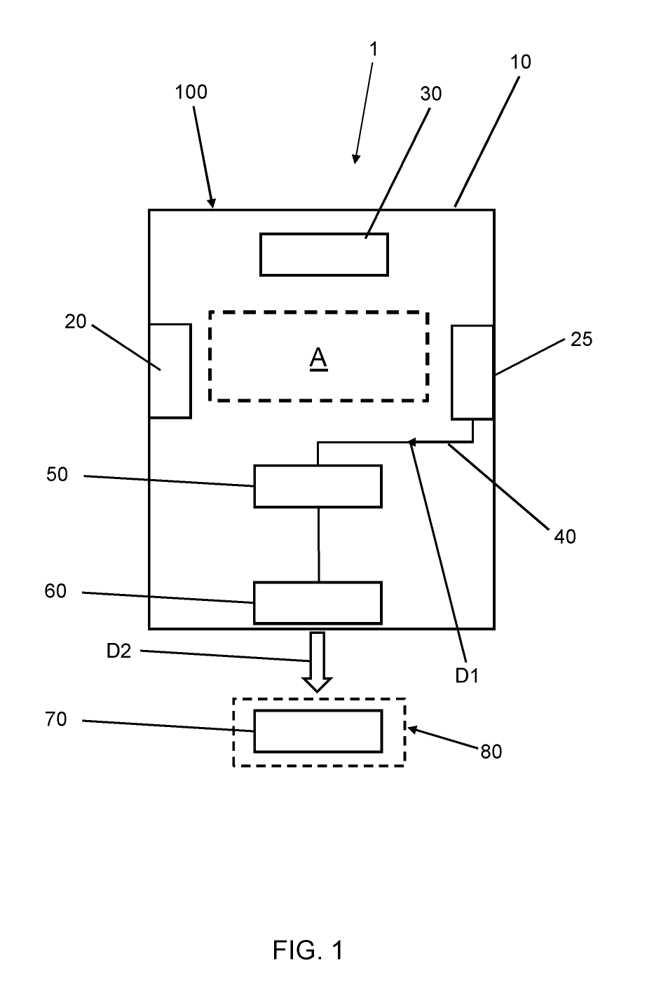

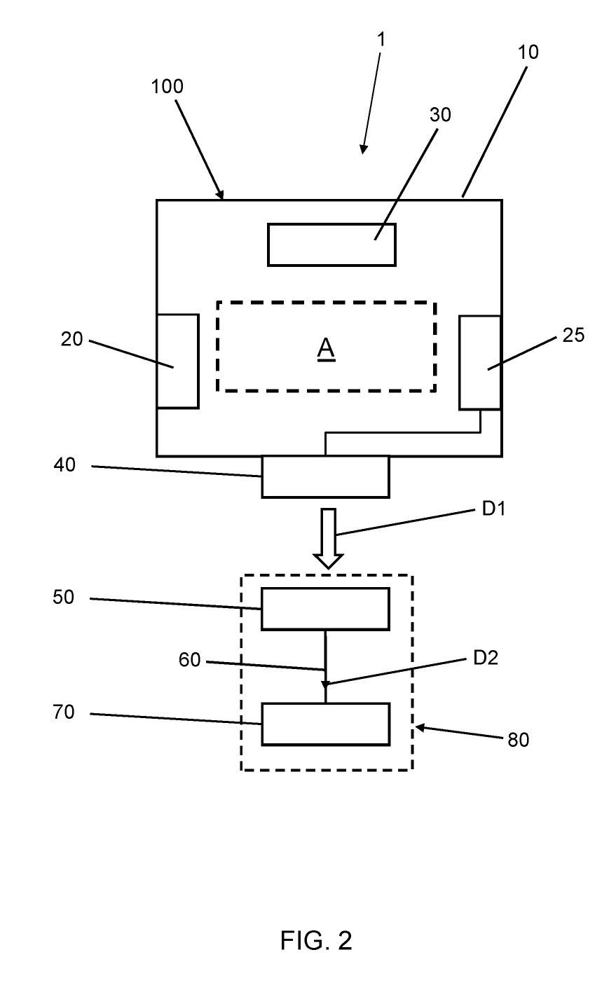

The system 1 (FIGS. 1, 2) comprises, in the first place, a frame 10. The frame 10 has a box-like shape, preferably a parallelepiped shape.

Preferably, the frame 10 is provided with a door that can be opened/closed in order to selectively allow access to the inside of the volume delimited by said frame 10.

The system 1 is also provided with operating means 30 for heating an active zone A defined within the internal volume of said frame 10.

Preferably, the active zone A is delimited by the so-called muffle, which is per se known and will not therefore be described any further herein.

The operating means 30 may comprise, by way of example, one or more electric resistors and one or more ventilation ducts. These features, which are per se known, will not be described any further.

In accordance with the invention, the system 1 further comprises an emitter device 20 for irradiating said active zone A with incident microwaves.

Such microwaves advantageously have a wavelength between 0.1 m (corresponding to a frequency of approx. 2-3 GHz) and 0.001 m (corresponding to a frequency of approx. 300 GHz).

The microwaves generated by the emitter device 20 act upon the food present in the active zone A.

Following said interaction, corresponding radiations are generated, which are conveniently detected by a detector device 25 included in the system 1.

Such corresponding radiations may comprise microwaves and/or infrared radiations and/or any other radiations deriving from the interaction between the incident microwaves and the food present in the active zone A.

The system 1 further comprises a first transmission unit 40 associated with at least said detector device 25 and configured for sending first data D1 to a processing unit 50.

Such first data D1 are representative of the radiations detected by said detector device 25.

Preferably, the processing unit 50 is configured for generating, based on said first data D1, one or more images X representative of food present in the active zone A.

In addition or as an alternative, the processing unit 50 is configured for determining, based on said first data D1, one or more of the following characteristic parameters Y:

a. a first parameter representative of the quality of the food present in the active zone;

b. a second parameter representative of a freshness of the food present in the active zone;

c. a third parameter representative of the volume occupied by the food present in the active zone;

d. a fourth parameter representative of the cooking level of the food present in the active zone; and

e. a set of parameters representative of a composition of the food present in said active zone, preferably comprising values concerning the relative quantity of skin and/or the relative quantity of meat and/or the relative quantity of water and/or the relative quantity of stuffing.

Advantageously, the first data D1 are representative of a spectral absorption of the food present in the active zone A, and allow the processing unit 50 to make the above-mentioned calculations.

Preferably, the system 1 further comprises a second transmission unit 60 for sending second data D2 to a display device 70.

The display device 70 is advantageously integrated into a portable auxiliary device 80.

The second data D2 may comprise the above-mentioned one or more images X and/or one or more of the above-mentioned characteristic parameters Y.

Conveniently, the frame 10, the operating means 30, the emitter device and the detector device are parts of an oven 100.

In particular, the oven 100 is of the combined type, wherein the emitter device 20 is also configured for being brought into an alternative operating condition in which it is adapted to warm up the food present in the active zone A.

In other words, the oven 100 may be able to warm up or cook food by using the operating means 30 and/or the emitter device 20. Advantageously, the latter is also configured for emitting radiations within the microwave range for analyzing the food present in the active zone A.

In one embodiment, both operations (food warming/cooking by microwaves and food analysis) can be carried out substantially at the same time: the radiations emitted by the emitter device 20 act upon the food, causing it to get warmed up and/or cooked. The corresponding radiations (e.g., within the microwave range) emitted by the food can be detected by the detector device 25, so that the first data D1 can be sent to the processing unit 50 through the first transmission unit 40 to allow analyzing the food during the preparation of the same.

In one embodiment (FIG. 1), the processing unit 50 and the second transmission unit 60 are integrated into said oven 100.

In this case, the first transmission unit 40 may comprise a simple wiring for connecting the detector device 25 to the processing unit 50. Most of the processing will then be carried out within the oven 100 itself. The second transmission unit 60, instead, will use wireless technology (e.g., Wi-Fi) for sending the second data D2 to the display device 70.

In a different embodiment (FIG. 2), the processing unit 50 and the second transmission unit 60 are integrated into the above-mentioned portable auxiliary device 80, separate from the oven 100.

In this case, the first transmission unit 40 will use wireless technology (e.g., Wi-Fi) for sending the first data D1 to the processing unit 50. The analysis will be carried out internally to the auxiliary device 80, and the second transmission unit 60 may comprise a simple wiring for connecting the processing unit 50 to the display device 70.

In the preferred embodiment, the auxiliary device 80 is a smartphone or a tablet, which can be connected to multiple apparatuses or household appliances within a household environment.

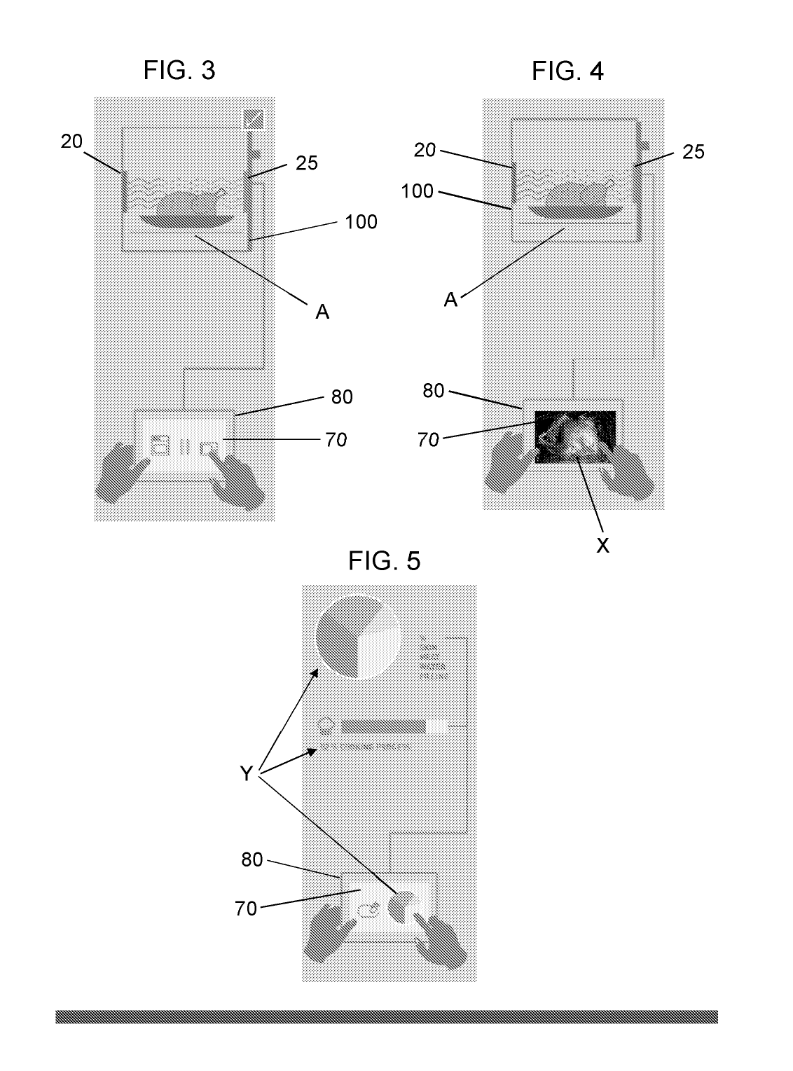

Suitable software (a so-called app) will allow the user to select the apparatus or system to interface to (e.g., the system 1). FIG. 3 schematically shows the selection operation.

In the case wherein the above-mentioned processing unit 50 is integrated into the auxiliary device 80, said app is also configured for carrying out the above-described processing, so as to make available to the user said one or more images X (FIG. 4) and/or one or more of said characteristic parameters (FIG. 5).

The invention offers significant advantages.

The system according to the invention allows, in fact, a more reliable evaluation of the cooking condition of the food being prepared, without requiring the oven door to be opened.

In addition, the invention allows the user to evaluate the conditions of the food positioned inside the oven, without even needing to be in proximity to the latter.

1-13. (canceled)

14. A system for warming up and/or cooking food, comprising:
a frame;
operating means for heating an active zone defined within the volume delimited by said frame;
an emitter device for irradiating said active zone with incident microwaves;
a detector device for detecting corresponding radiations coming from said active zone; and
a first transmission unit associated with at least said detector device and configured for sending first data, representative of said corresponding radiations, to a processing unit.

15. The system of claim 1, wherein said corresponding radiations are generated by the interaction between said incident microwaves and food present in said active zone.

16. The system of claim 1, wherein said processing unit is configured for generating, based on said first data, one or more images representative of food present in said active zone.

17. The system of claim 1, wherein said processing unit is configured for determining, based on said first data, one or more of the following characteristic parameters:
a first parameter representative of the quality of the food present in the active zone;
a second parameter representative of a freshness of the food present in the active zone;
a third parameter representative of the volume occupied by the food present in the active zone;
a fourth parameter representative of the cooking level of the food present in the active zone; and
a set of parameters representative of a composition of the food present in said active zone, preferably comprising values concerning the relative quantity of skin and/or the relative quantity of meat and/or the relative quantity of water and/or the relative quantity of stuffing.

18. The system of claim 1, further comprising a second transmission unit for sending second data to a display device.

19. The system of claim 18, wherein said second data comprises one or more images representative of food present in said active zone.

20. The system of claim 18, wherein said second data comprises one or more of the following characteristic parameters:
a first parameter representative of the quality of the food present in the active zone;
a second parameter representative of a freshness of the food present in the active zone;
a third parameter representative of the volume occupied by the food present in the active zone;
a fourth parameter representative of the cooking level of the food present in the active zone; and
a set of parameters representative of a composition of the food present in said active zone, preferably comprising values concerning the relative quantity of skin and/or the relative quantity of meat and/or the relative quantity of water and/or the relative quantity of stuffing.

21. The system of claim 1, wherein said frame, said operating means, said emitter device, said detector device, and said first transmission unit are parts of an oven.

22. The system of claim 21, wherein said oven is of the combined type, wherein said emitter device is configured for being brought into an operating condition in which it warms up the food present in said active zone.

23. The system of claim 21, wherein said processing unit and said second transmission unit are integrated into said oven.

24. The system of claim 23, wherein said display device is integrated into a portable auxiliary device separate from said oven.

25. The system of claim 21, wherein said processing unit and said second transmission unit are integrated into a portable auxiliary device separate from said oven.

26. The system of claim 25, wherein said display device is integrated into said auxiliary device.
